(19) United States
(12) Patent Application Publication
(10) Pub. No.: US 2025/0237875 A1
(43) Pub. Date: Jul. 24, 2025

(54) ELECTRONIC DEVICE SUPPORT

(71) Applicant: Apple Inc., Cupertino, CA (US)

(72) Inventor: Paul X. Wang, Cupertino, CA (US)

(21) Appl. No.: 18/418,195

(22) Filed: Jan. 19, 2024

(51) Int. Cl. G02B 27/01

(52) U.S. Cl. CPC G02B 27/0176; G02B 2027/0178

(57) ABSTRACT

A head-mountable device can include a display frame, a display carried by the display frame, an arm rotatably connected to the display frame at a first joint, and a head-engagement member rotatably coupled to the arm at a second joint.

### FIELD

The described embodiments relate generally to electronic devices, such as electronic glasses or head-mountable devices. More particularly, the present embodiments relate to electronic glasses including a support.

### BACKGROUND

Recent advances in portable computing have enabled head-mountable devices that provide augmented and virtual reality experiences to users. Various component of these devices, such as display windows, viewing frames, securement arms, speakers, batteries, and other components, operate together to provide an immersive and comfortable experience for the user. However, the anatomy of each user's head is unique. One user's head can be larger than another, or one head can be a different shape than another. Similarly, variations of a surface profile (e.g., bony crests and valleys) are prevalent across different users. Other anatomical features, including relative positions of a user's nose, forehead, and ears, can also vary widely between users. The anatomical variety of heads presents a challenge for head-mountable devices designed for comfort and reliability.

In some head-mountable devices, for example, securement arms that extend along, or make contact with, opposing sides of a user's head can be used to secure the device to the user's head. However, the dimensions, angles, shape, and other physical characteristics of the arms that may be sufficient to comfortably and reliably secure the device to one user's head may not be sufficient to comfortably and reliably secure the device to another user's head. A weight of some conventional head-mountable devices may make universal comfort more difficult. Further, the securement arms of conventional head-mountable devices are not always compatible (or do not always provide a reliable fit to a user's head), particularly for certain user activities (e.g., running or exercising) or use of certain software applications (e.g., vigorous games, productivity applications). Accordingly, there is a need for head-mountable devices and systems that can improve user comfort, in addition to improved reliability for everyday activities and software applications.

### SUMMARY

One aspect of the present disclosure relates to a head-mountable device. The head-mountable device can include: a display frame; a display carried by the display frame; an arm rotatably coupled to the display frame at a first joint; and a head-engagement member rotatably coupled to the arm at a second joint.

In some examples, the arm includes a surface. In addition, the head-engagement member can be rotatable between a stowed position adjacent to the surface and a deployed position away from the surface. In one example, the head-engagement member includes a spring. In another example, the head-engagement member includes a preloaded material. In a certain example: the head-engagement member is slidable along a length of the arm. In one or more examples, the head-engagement member includes a friction interface engageable with skin or hair of a user. In at least one example, the friction interface includes a plurality of fingers that, when engaged with the skin or the hair of the user, is oriented to at least partially support a weight of the head-mountable device. In one example, a portion of the head-engagement member is conformable to a head shape of a user. In particular examples, a portion of the head-engagement member is length adjustable. In some examples, a portion of the head-engagement member includes an overhead linkage positionable against the display frame. In one example, the first joint and the second joint are positioned on a proximal portion of the arm. In certain examples, the head-engagement member is detachable from the arm.

Another aspect of the present disclosure relates to a wearable apparatus. The wearable apparatus can include a housing, a viewing window secured to the housing, a foldable arm connected to the housing and rotatable in a first plane, and a support arm connected to the foldable arm and rotatable in a second plane perpendicular to the first plane.

In some examples, the second plane is parallel to a longitudinal axis of the foldable arm. In a particular example, the support arm is positionable inside a profile of the foldable arm. In at least one example, the support arm is positionable adjacent to an outer surface of the foldable arm that faces a direction opposite a head of a user when the wearable apparatus is donned. In one or more examples, the support arm is biased into the foldable arm when the support arm is in a stowed position.

Yet another aspect of the present disclosure relates to a removable support assembly for electronic glasses. The removable support assembly can include an adjustable support fin having a head-engagement surface, and a glasses-arm connector coupled to the support fin and removably attachable to a glasses arm of the electronic glasses.

In one or more examples, the removable support assembly further includes the glasses arm of the electronic glasses, wherein the glasses arm is removably attachable to a glasses frame of the electronic glasses. In these or other examples, the glasses arm further includes a proximal end connectable to the glasses frame of the electronic glasses, a distal end opposite the proximal end, and an electronics assembly coupled to the glasses arm between the proximal end and the distal end, the electronics assembly including a power supply and a processor. In one or more examples, the removable support assembly further includes a housing that couples the support fin to the glasses-arm connector, wherein, the housing defines a recess, the recess sized and shaped to receive the glasses arm; and the glasses-arm connector is positioned at the recess.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a top profile view of a head-mountable device donned on a user's head in accordance with one or more examples of the present disclosure.

FIGS. 2-3 respectively illustrate side views of a head-mountable device having example stowed and deployed positions of a head-engagement member in accordance with one or more examples of the present disclosure.

FIGS. 4-6 illustrate side views of a head-mountable device having a head engagement member with example positions of a pivot joint in accordance with one or more examples of the present disclosure.

FIG. 7 illustrates a side view of a head-mountable device having an example slideable implementation of a head-engagement member in accordance with one or more examples of the present disclosure.

FIG. 8 illustrates a side view of a head-mountable device having a removable support assembly in accordance with one or more examples of the present disclosure.

FIG. 9 illustrates a side view of a head-mountable device having a removable support assembly in accordance with one or more examples of the present disclosure.

FIG. 10 illustrates a front perspective view of an example head-mountable device including a head-engagement member in accordance with one or more examples of the present disclosure.

FIGS. 11-14 respectively illustrate front perspective views of an arm having example configurations of a head-engagement member positioned adjacent to various surfaces of the arm, including an outer surface, a top surface, an inner surface, and a bottom surface in accordance with one or more examples of the present disclosure.

FIGS. 15-17 illustrate side views of a distal end of an arm having an example widened portion in accordance with one or more examples of the present disclosure.

FIG. 18 illustrates a front view of an arm with a head-engagement member in a deployed position and having an example head-engagement surface in accordance with one or more examples of the present disclosure.

FIG. 19 illustrates a side view of a head-mountable device with a head-engagement member having an expandable bladder in accordance with one or more examples of the present disclosure.

FIGS. 20A-20B illustrate respective cross-sectional views of the head-engagement member from FIG. 19 in stowed and deployed positions in accordance with one or more examples of the present disclosure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates generally to electronic devices, specifically a head-mountable electronic device (or head-mountable device). In at least one example, a head-mountable device can include a viewing frame and a securement arm (or strap and/or band) extending from the viewing frame. Examples of head-mountable electronic devices can include virtual reality or augmented reality devices that include an optical component. In the case of augmented reality devices, optical eyeglasses or frames can be worn on the head of a user such that optical windows, which can include transparent windows, lenses, or displays, can be positioned in front of the user's eyes. In another example, a virtual reality device can be worn on the head of a user such that a display screen is positioned in front of the user's eyes. The viewing frame can include a housing (e.g., a display housing or display frame) or other structural components supporting the optical components, for example lenses or display windows, or various electronic components.

Additionally, a head-mountable electronic device can include one or more electronic components used to operate the head-mountable electronic device. These components can include any components used by the head-mountable electronic device to produce a virtual or augmented reality experience. For example, electronic components can include one or more projectors, waveguides, speakers, processors, batteries, circuitry components including wires and circuit boards, or any other electronic components used in the head-mountable device to deliver augmented or virtual reality visuals, sounds, and other outputs. The various electronic components can be disposed within the electronic component housing. In some examples, the various electronic components can be disposed with in or attached to one or more of the display frame, the electronic component housing, and/or the securement arm.

In a particular example, the present disclosure relates to a head-engagement member that is rotatably coupled to an arm of the head-mountable device. The head-engagement member can be rotated in and out relative to the arm to selectively engage a user's head. By engaging a user's head, the head-engagement member can offload a perceived pressure or weight felt by the user during the wearing of the head-mountable device. In some examples, the head-engagement member can improve user comfort and alleviate (or prevent) fatigue during prolonged use of the head-mountable device. Likewise, in some examples, the head-engagement member of the present disclosure can improve a fit to a user's head (e.g., by more reliably gripping, contacting, or conforming to a user's hair, skin, or scalp). To do so, the head-engagement member can be utilized in a variety of positional configurations and/or with various features to engage a user's head.

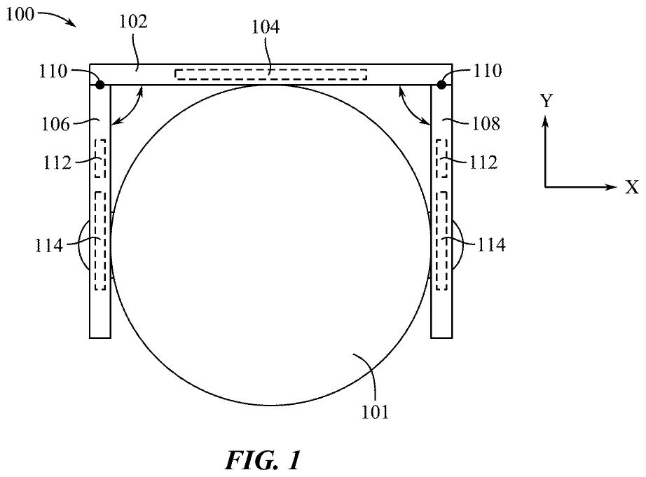

These and other embodiments are discussed below with reference to FIGS. 1-20B. However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top profile view of head-mountable device 100 donned on a user's head in accordance with one or more examples of the present disclosure. While the present systems and methods are described in the context of a head-mountable device 100, the systems and methods can be used with any wearable apparatus, wearable electronic device, or any apparatus or system that can be physically attached to a user's body, but are particularly relevant to an electronic device worn on a user's head.

The head-mountable device 100 can include a display frame 102 to secure one or more optical lenses or display windows in front of the eyes of the user. As used herein, the terms “display frame,” “frame,” and “housing” can refer to a portion of a head-mountable device that contains (e.g., houses or carries) a display 104, also referred to as a display window or viewing window. As used herein, the terms “display,” “display window,” or “viewing window” can refer to a lens, a cover glass, or another surface designed to display a projected image on a surface, or any other component that presents visual media or information to a user. In particular implementations, the display 104 can include a display/screen for presenting augmented reality visualizations, a virtual reality visualization, or other suitable visualization. The display 104 can be part of an optical module, which can include sensors, cameras, light emitting diodes, an optical housing, a cover glass, sensitive optical elements, and the like.

The head-mountable device 100 can also include one or more arms 106, 108 secured to the display frame 102 and extending distally toward the rear of the user's head 101. The securement arms 104a, 104b can apply opposing pressures to the sides of the user's head 101, as shown, to secure the head-mountable device 100 to the user's head 101. The securement arms 106, 108 can also rest on the user's ears and/or can secure the head-mountable device 100 via friction or pressure between the arms 106, 108 and the user's head 101.

In these or other examples the arms 106, 108 are rotatably coupled to the display frame 102 via pivot joints 110. In particular, the arms 106, 108 can pivot at the pivot joints 110 so as to pivot in the indicated X-Y plane.

In some examples, at least one of the arms 106, 108 can include an electronics assembly 112. The term “electronics assembly” refers to an arrangement of one or more electrical elements, such as a power supply and a processor. Additionally or alternatively, an electronics assembly can include a subassembly, an enclosure, or a shell dedicated for housing certain electronics. In these or other examples, the term “power supply” refers to any power source that supplies power to one or more components of the head-mountable device 100 (e.g., to charge a battery or power a processor). For example, a power supply can include fuel cells, battery cells, generators, alternators, solar power converters, motion-based converters (e.g., that convert vibrations or oscillations into power), and the like. In particular implementations, a power supply can convert alternating current to direct current (or vice-versa) for charging or recharging components of the head-mountable device 100. Some particular examples of a power supply can include a switched mode power supply, an uninterruptible power supply, an alternating current power supply, a direct current power supply, a regulated power supply, a programmable power supply, a computer power supply, and/or a linear power supply.

Further, a processor of the electronics assembly 112 can include any of a variety of processors (e.g., a system-on-chip, integrated circuit, driver, application processor, crossover processor, etc.). In some examples, the electronics assembly 112 further includes one or more memory devices (e.g., individual nonvolatile memory, processor-embedded nonvolatile memory, random access memory, memory integrated circuits, DRAM chips, stacked memory modules, storage devices, memory partitions, etc.). In particular examples, the electronics assembly 112 further includes one or more of input/output ports, counters, timers, etc. It will be appreciated that such an electronics assembly 112 can be mounted on a printed circuit board (e.g., a rigid circuit board or a flexible printed circuit).

In addition, the head-mountable device 100 can include a head-engagement member 114. As used herein, the terms “head-engagement member” or “support arm” refer to an appendage attachable to at least one of the arms 106, 108. In these or other examples, the head-engagement member 114 can include an appendage that is rotatably attached to one or both arms 106, 108. Greater detail of the head-engagement member 114 is provided below in relation to the subsequent figures. However, as noted above, the head 101 of the user can be a unique shape and size with certain anatomical structures and positional configurations that vary across a user base. For example, relative positions of a user's nose, forehead, and ears, can vary widely between users. In these or other examples, the structure of the head-engagement member 114 can be used to provide enhanced user comfort (e.g., by conforming to certain portions of the head 101, by at least partially offloading or redistributing a weight of the head-mountable device 100, etc.). Likewise, the head-engagement member 114 of the head-mountable device 100 can be deployed for providing an improved or more reliable (e.g., robust) fit onto the head 101 during different user activities (e.g., running, exercising, etc.) and/or use of software applications.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

As mentioned above, the head-mountable device 100 can include the head-engagement member 114. The following description discusses example implementations of the head-engagement member 114 and associated positions relative to an arm (e.g., a stowed position and a deployed position).

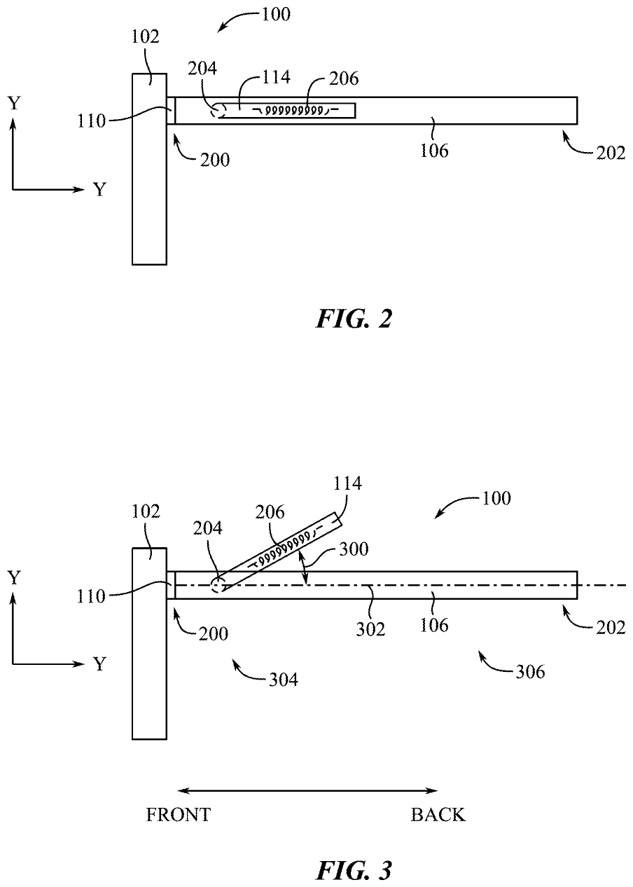

FIGS. 2-3 illustrate side views of the head-mountable device 100 having example stowed and deployed positions of the head-engagement member 114 in accordance with one or more examples of the present disclosure. In particular, FIGS. 2-3 show the head-engagement member 114 is pivotably attached to the arm 106 at a pivot joint 204. The pivot joint 204 can allow the head-engagement member 114 to rotate in a plane that is substantially perpendicular to the plane of rotation for the arm 106. Indeed, as shown in FIGS. 2-3, the head-engagement member 114 can rotate in the Y-Z plane; whereas the arm 106 can pivot in the X-Y plane (indicated in FIG. 1). Additionally shown, the Y-Z plane of rotation for the head-engagement member 114 can be parallel to the longitudinal axis 302 for the arm 106.

The pivot joint 204 can include any number of various types of joints. In some examples, the pivot joint 204 can include a revolute joint, a prismatic joint, a universal joint, or a spherical joint. Some particular examples of the pivot joint 204 can include a ball-and-socket joint, condyloid joint, hinged joint, serial manipulator joint, knuckle joint, synovial joint, and the like.

The pivot joint 204 can be positioned between a proximal end 200 of the arm 106 (which is connected to the display frame 102 at the pivot joint 110) and a distal end 202 opposite the proximal end 200. The pivot joint 204 can be positioned at a variety of different positions along the arm 106, as will be described in relation to subsequent figures. For example, the pivot joint 204 can be positioned in a front half 304—the proximal portion adjacent the proximal end 200—of the arm 106 (e.g., the same half as the pivot joint 110 of the arm 106 as shown in FIGS. 2-3). Alternatively, the pivot joint 204 can be positioned in a rear half 306—the distal portion adjacent the distal end 202—of the arm 106. In these or other examples, a given “half” of the arm 106 can refer to a portion of the arm 106 in relation to half of a distance along the longitudinal axis 302 between the proximal end 200 and the distal end 202. Additionally or alternatively, a given “half” of the arm 106 can refer to an anatomical relationship of the arm 106 with portions of a user's head (e.g., a front half forward of the user's ears or a rear half behind the user's ears).

In addition, FIGS. 2-3 show the head-engagement member 114 as including an optional spring 206 or other biasing element. The spring 206 can be positioned within the head-engagement member 114. Additionally or alternatively, the spring 206 can connect discrete portions (e.g., a first portion and a second portion) of the head-engagement member 114. In these or other examples, the spring 206 can provide a biasing force and/or a damping force against a user's head. Additionally or alternatively, the spring 206 can impart compliance, elasticity, or flexure to one or more portions of the head-engagement member 114. A variety of springs can be utilized. For example, the spring 206 can include a torsion spring, an extension spring, a spiral (helical) spring, a compression spring, leaf spring, coil spring, constant-force spring, gas spring, garter spring, helical compression spring, flat spring, disk spring, and the like. Likewise, various materials can be utilized to form the arm 106 (e.g., metal, plastic, or composite materials). Additionally, alternatives to a spring can be included, including, but in no way limited to, pistons, hydraulic actuators, pneumatic actuators, electro-mechanical actuators, and the like.

Additionally or alternatively to the spring 206, the head-engagement member 114 can include a preloaded material to perform any of the functions or impart any of the characteristics described above. A preloaded material refers to a type of material that can, in a resilient manner, bend, deform, or elastically alter its shape. A preloaded material can be formed according to a force-deflection curve. In particular examples, a preloaded material includes a preformed segment of sheet metal, plastic, or a composite material.

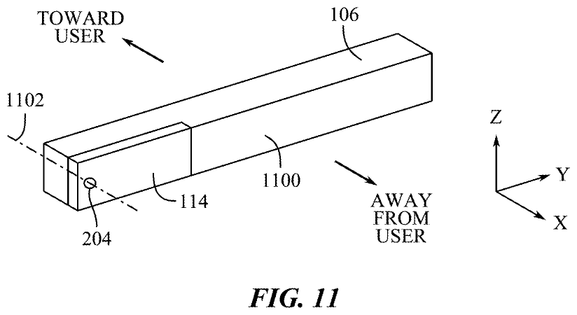

Specifically in FIG. 2, the head-engagement member 114 is positioned in a stowed position. A stowed position can refer to a home position, a base position, a hidden position, an aligned position, a profile position, and the like. In these or other examples, a stowed position refers to the position of the head-engagement member 114 when not in use. For example, in a stowed position, most portions (if not all) of the head-engagement member 114 can be positioned adjacent to (or in direct contact with) a surface of the arm 106. For example, the head-engagement member 114 can be biased into the arm 106 when the head-engagement member 114 is in the stowed position. In particular examples, the head-engagement member 114 is positioned inside a profile of the arm 106 (e.g., in alignment with a general curvature or outer shape of the arm 106). Various stowed configurations of the head-engagement member 114 relative to certain surfaces of the arm 106 are described further in relation to FIGS. 11-14.

In contrast, FIG. 3 shows the head-engagement member 114 in a deployed position. A deployed position can refer to an adjusted position, angled position, head contact position, extended position, support position, weight distribution position, a friction engagement position, etc. In these or other examples, a deployed position refers to a position of the head-engagement member 114 when in-use or otherwise moved away from the stowed position shown in FIG. 2. In particular examples, the deployed position of the head-engagement member 114 can refer to a range of angles (i.e., of an angle 300) between the head-engagement member 114 and a longitudinal axis 302 of the arm 106. In some examples, the angle 300 for a deployed position of the head-engagement member 114 can range from about 5 degrees to about 340 degrees, about 10 degrees to about 270 degrees, about 25 degrees to about 45 degrees, about 45 degrees to about 120 degrees, or about 60 degrees to about 100 degrees. The angle 300 can be user adjusted with continuous resolution (or between predetermined angular increments), as may be desired. Additionally or alternatively, the angle 300 can be adjusted in an automated fashion (e.g., using one or more motors in the head-mountable device 100).

It will be appreciated that the head-engagement member 114 can include a variety of different shapes and cross-sectional profiles. Indeed, the head-engagement member 114 is not limited to rectangular shapes or cross-sections. For example, the head-engagement member 114 can include a U-shaped cross-section (e.g., in which the rounded portion can contact the user's head).

Any of the features, components, and/or parts, including the arrangements and configurations thereof shown in FIGS. 2-3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 2-3.

As mentioned above, the pivot joint 204 can be positioned at a variety of different positions along the arm 106. The following description discusses a few example positions of the pivot joint 204, in addition to various deployable configurations.

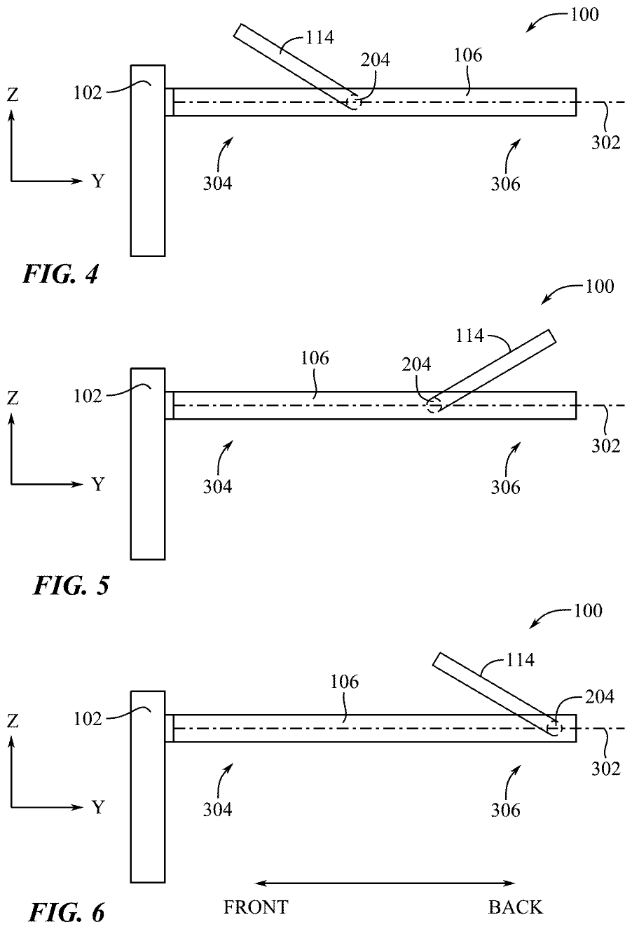

FIGS. 4-6 illustrate side views of the head-mountable device 100 having a head engagement member with example positions of the pivot joint 204 in accordance with one or more examples of the present disclosure. As shown in FIG. 4, the pivot joint 204 can be more centrally located along the arm 106. In this position, the head-engagement member 114 can extend frontward and open up (i.e., deploy) in a direction facing the front half 304 (or facing toward the display frame 102).

FIG. 5 shows another example position of the pivot joint 204. As illustrated in FIG. 5, the pivot joint 204 can also be more centrally located (e.g., away from the proximal and distal ends 200, 202). In contrast to FIG. 4, however, the head-engagement member 114 can extend rearward and open up (i.e., deploy) in a direction facing the rear half 306 (or facing away from the display frame 102).

FIG. 6 shows yet another example position of the pivot joint 204. In FIG. 6, the pivot joint 204 is positioned in the rear half 306 adjacent the distal end 202. Like in FIG. 4, the head-engagement member 114 can extend frontward and open up (i.e., deploy) in a direction facing the front half 304 (or facing toward the display frame 102). Regardless of the position of the pivot joint 204, the head-engagement member 114 can deploy in any direction and at any angle, according to various examples.

Any of the features, components, and/or parts, including the arrangements and configurations thereof shown in FIGS. 4-6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 4-6. As mentioned above, the head-engagement member 114 can include slidable implementations. The following description discusses an example in which the head-engagement member 114 can slide along the arm 106.

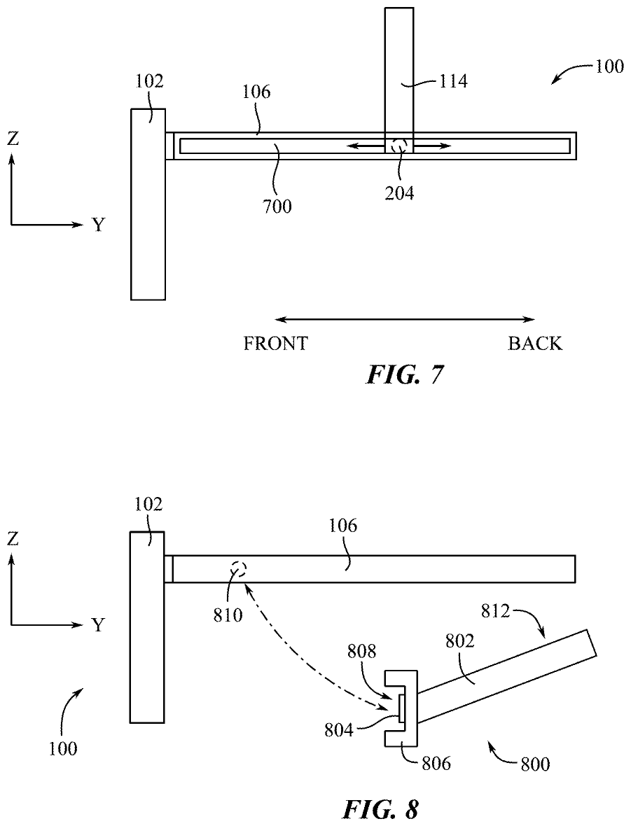

FIG. 7 illustrates a side view of the head-mountable device 100 having an example slideable implementation of the head-engagement member 114 in accordance with one or more examples of the present disclosure. As shown, the arm 106 can include a channel 700 defined by the body of the arm 106. In these or other examples, the pivot joint 204 can be sized and shaped to fit within the channel 700. In this manner, the pivot joint 204 can slide forward and backward (as constrained by the channel 700), thereby allowing the head-engagement member 114 to correspondingly translate across the length of the arm 106.

It will be appreciated that the channel 700 can include a variety of different dimensions. In some examples, the channel 700 extends across an entire length of the arm 106 (where “length” can refer to the longitudinal distance along the Y-direction). In other examples, the channel 700 extends partially across the length of the arm 106.

Further, it will also be appreciated that the head-engagement member 114 can be secured (or locked) in position within the channel 700 in a variety of different ways. In some examples, the head-engagement member 114 can include a detent engagement with the arm 106. Additionally or alternatively, the head-engagement member 114 can include a toothed engagement with the arm 106. The head-engagement member 114 can also be secured in place within the channel 700 via magnets, fasteners, or other locking mechanisms (e.g., features that interlock, mate, interfere, snap together, etc.).

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7. As detailed above, the head-mountable device 100 can include implementations of the head-engagement member 114 in which the head-engagement member 114 is detachable from the arm 106. The following discussion therefore includes further description regarding examples of a detachable head-engagement member (e.g., as part of a detachable assembly).

FIG. 8 illustrates a side view of the head-mountable device 100 having a removable support assembly 800 in accordance with one or more examples of the present disclosure. The removable support assembly 800 can be compatible with a variety of head-mountable devices, including the head-mountable device 100. In particular implementations, the removable support assembly 800 is interchangeable or cross-compatible with other arms of electronic glasses.

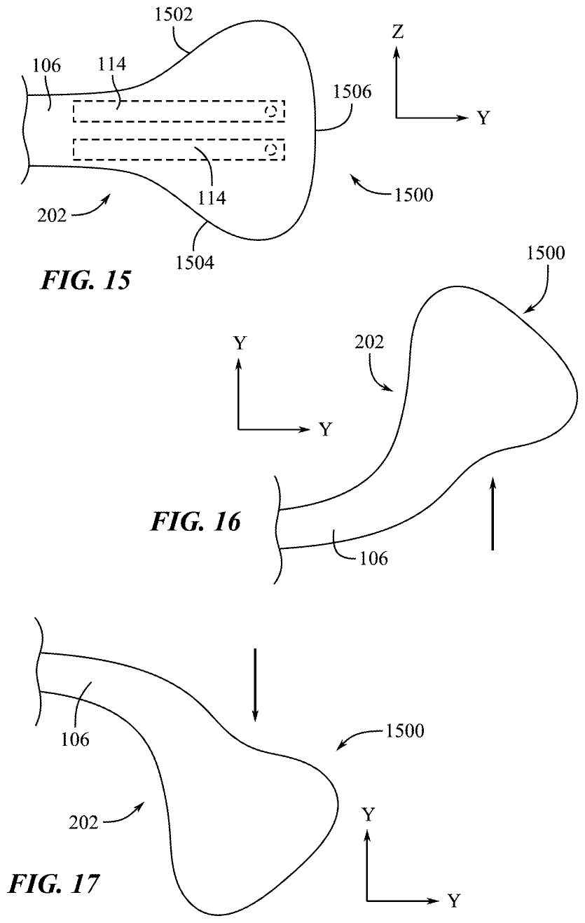

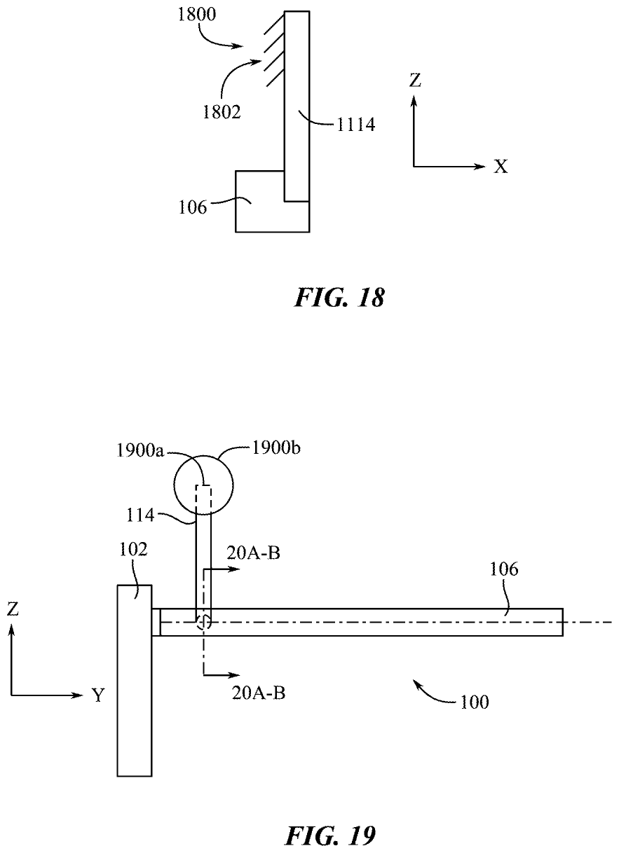

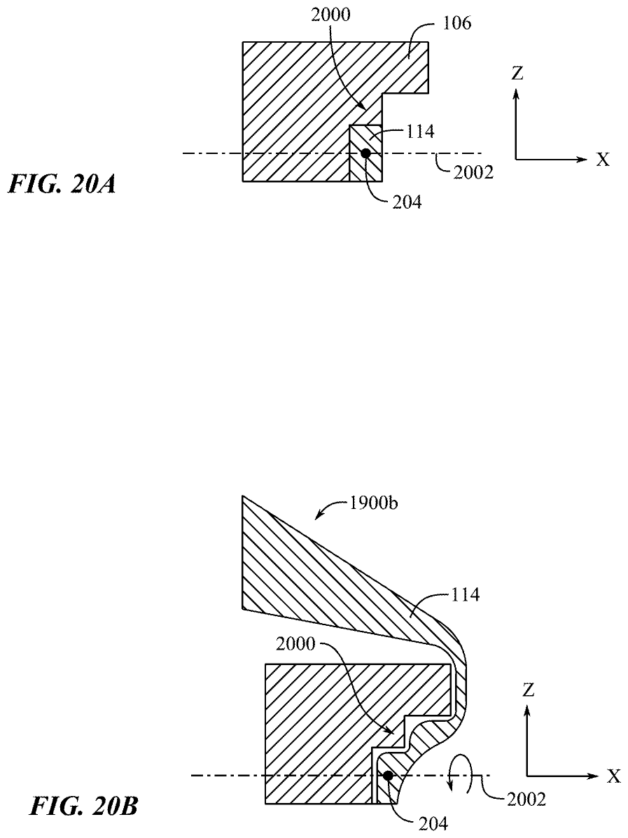

As shown, the removable support assembly 800 can include a support fin 802 (which can be the same as or similar to the head-engagement member 114 discussed above). The support fin 802 can include a head-engagement surface 812. The head-engagement surface 812 can include a portion of the support fin 802 that can contact a user's head when the support fin 802 is deployed. In some examples, the head-engagement surface 812 is malleable, conformable, cushioned, etc. to provide a comfortable fit with a user's head. In particular implementations, the head-engagement surface 812 includes a shaped configuration (e.g., a widened configuration, a fanned configuration, a spread configuration, etc.) to better distribute a weight of the head-mountable device 100 to a user's head, as will be discussed below in relation to FIGS. 15-17. In some examples, the head-engagement surface 812 includes a friction interface (e.g., to engage a user's hair, skin, or scalp) as will be discussed below in relation to FIG. 18. In other examples, the head-engagement surface 812 includes an expandable portion, as discussed below in relation to FIGS. 19-20B.

In addition, the removable support assembly 800 can include a glasses-arm connector 804. The glasses-arm connector 804 can be coupled to the support fin 802 and is removably attachable to the arm 106. In particular implementations, the glasses-arm connector 804 includes a magnetic connector, interlocking connector, mating connector, hook and loop strip connector, electrical/power connector, and the like. In these or other examples, the glasses-arm connector 804 corresponds to a mating connection 810 positioned at the arm 106.

In certain examples, the glasses-arm connector 804 can be positioned on or within a housing 806 that couples the support fin 802 to the glasses-arm connector 804. The housing 806 can include a shell, enclosure, casing, fitting, or attachment piece for securing the support fin 802 to the arm 106. In particular examples, the housing 806 defines a recess 808 sized and shaped to receive the arm 106. In some examples, the glasses-arm connector 804 is positioned at the recess 808 (e.g., so as to secure the housing 806 to the arm 106 via the mating connection 810).

It will be appreciated that the removable support assembly 800 can be removably attached to the arm 106 in a variety of different locations across the length of the arm 106. For instance, in some examples, the arm 106 can include multiple mating connections 810 across the length of the arm 106. In this manner, the user can attach the removable support assembly 800 to the arm 106 in a desired location.

Any of the features, components, and/or parts, including the arrangements and configurations thereof shown in FIG. 8 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8.

As briefly discussed above, the head-mountable device 100 can include implementations of the arm 106 in which the arm 106 itself is detachable from the head-mountable device 100. The following discussion therefore includes further description regarding examples of a detachable arm (e.g., as part of a detachable assembly).

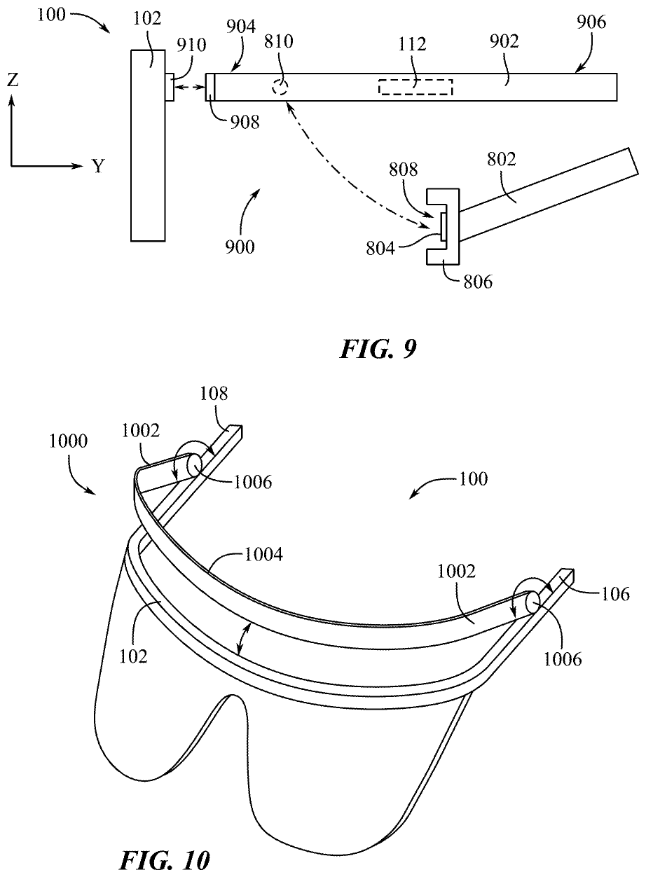

FIG. 9 illustrates a side view of the head-mountable device 100 having a removable support assembly 900 in accordance with one or more examples of the present disclosure. The removable support assembly 900 can include aspects of the removable support assembly 800 discussed above for a detachable head-engagement member, including the support fin 802, the glasses-arm connector 804, and the housing 806. The removable support assembly 900 can further include a detachable glasses arm 902. The glasses arm 902 can be removably attachable to a glasses frame (e.g., the display frame 102) of the head-mountable device 100. It will thus be appreciated that, in some implementations, the detachable glasses arm 902 can be interchangeable or cross-compatible with other display frames.

In these or other examples, the detachable glasses arm 902 can include a proximal end 904 attachable to the display frame 102, and a distal end 906 opposite the proximal end 904. In particular examples, the proximal end 904 can include a connector 908. The connector 908 can include a magnetic connector, interlocking connector, mating connector, electrical/power connector, data connector, etc. that can correspondingly engage the display frame 102 via a mating connector 910.

Further shown, the detachable glasses arm 902 can include the electronics assembly 112 discussed above in relation to FIG. 1. In particular examples, the detachable glasses arm 902 can include at least one of a power supply or a processor. In this manner, the detachable glasses arm 902 can be swapped out for another glasses arm (e.g., having a full battery) while a battery of the detachable glasses arm 902 is charged.

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9.

As briefly discussed above, the head-mountable device 100 can include implementations of the head-engagement member 114 that include an overhead linkage to engage a top-of-head, forehead, or middle portion of a user's head. The following discussion therefore includes further description regarding examples of a head-engagement member that can span between the arms 106, 108.

FIG. 10 illustrates a front perspective view of an example of the head-mountable device 100 including a head-engagement member 1000 in accordance with one or more examples of the present disclosure. As shown, the head-engagement member 1000 is rotatable up and down to provide a desired fit against the user's head. In particular, the head-engagement member 1000 can include pivot joints 1006 that are positioned on the arms 106, 108. Via the pivot joints 1006, the head-engagement member 1000 can rotate from a stowed position (where the head-engagement member 1000 rests flush against the top of the display frame 102 and the arms 106, 108) to a deployed position in which the head-engagement member 1000 is rotated away from the display frame 102 and the arms 106, 108. In these or other examples, the head-engagement member 1000 can rotate between about 5 degrees and about 180 degrees, between about 15 degrees and about 120 degrees, between about 30 degrees and about 90 degrees, or about 45 degrees to about 60 degrees.

Further shown, the head-engagement member 1000 can specifically include side portions 1002 and a middle portion 1004. The side portions 1002 can be the same as or similar to the head-engagement member 114 or the support fin 802 discussed above. In particular, the side portions 1002 can rotatably couple the head-engagement member 1000 to the arms 106, 108 via the pivot joints 1006. When in the stowed position, the side portions 1002 can rest on the top surface of the arms 106, 108.

In addition, the middle portion 1004 can join the respective side portions 1002. In certain examples, the middle portion 1004 can include an overhead linkage that is positionable against the top surface of the display frame 102. The middle portion 1004 can provide increased surface area (and therefore increased weight distribution) for the head-mountable device 100.

In these or other examples, the side portions 1002 and the middle portion 1004 can be integrally formed together (e.g., as a single-piece unit). Additionally or alternatively, the side portions 1002 and the middle portion 1004 (as discrete segments or portions) can be attached together, whether permanently or in a removable fashion.

In some examples, at least one of the side portions 1002 or the middle portion 1004 is conformable to a head shape of a user. Such “conformable” portions can include malleable portions, adjustable portions, form-fitting portions, customized portions, compressible portions, etc. In certain implementations, conformable portions can include a loose cable or wire that interconnects a series of support blocks (e.g., foam blocks, silicone pods, etc.) that can interface with the user's head in a conformable fashion.

Additionally or alternatively, in some examples, at least one of the side portions 1002 or the middle portion 1004 is length adjustable. Length adjustable refers to the ability of the head-engagement member 1000 to lengthen, stretch, adjust, telescope, extend, shrink, contract, etc. Length adjustability for at least one of the side portions 1002 or the middle portion 1004 can allow the head-engagement member 1000 to comfortably (and universally) fit different users' heads, including heads of all shapes and sizes. Thus, in some examples, at least one of the side portions 1002 or the middle portion 1004 can include a stretchy or elastic fabric. Further, in some examples, at least one of the side portions 1002 or the middle portion 1004 can include telescoping segments. In a particular example, at least one of the side portions 1002 or the middle portion 1004 can include a segment with predetermined notches or adjustment holes to allow a desired length.

Any of the features, components, and/or parts, including the arrangements and configurations thereof shown in FIG. 10 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 10.

As briefly discussed above, the head-mountable device 100 can include a variety of different positional configurations for a head-engagement member. The following discussion therefore includes further description regarding example orientations of a head-engagement member, as well as different surfaces of an arm that can be arranged adjacent to the head-engagement member.

FIGS. 11-14 respectively illustrate front perspective views of the arm 106 having example configurations of the head-engagement member 114 positioned adjacent to various surfaces of the arm 106, including an outer surface, a top surface, an inner surface, and a bottom surface in accordance with one or more examples of the present disclosure. The various surfaces of the arm 106 can engage (e.g., support, touch, hold, lock-in-place, etc.) the head-engagement member 114 when in the stowed position. In particular examples, an arm surface can define a recess or cutaway that is sized and shaped to receive the head-engagement member 114. In this manner, the head-engagement member 114 can be positioned within the recess or cutaway such that the head-engagement member 114 is positioned inside a profile of the arm 106. As used herein, the term “profile” refers to a general curvature or outer shape of an object, particularly the arm 106. Accordingly, in some examples, being positioned inside a profile of the arm 106 can refer to the positioning of the head-engagement member 114 as being consistent with the silhouette of the arm 106, being aligned with the arm 106 in a non-protruding or non-bulging fashion, or being congruent with geometrical lines of the arm 106. In these or other examples, the head-engagement member 114 is positioned inside a profile of the arm 106 when in a stowed position, and outside the profile of the arm 106 when in a deployed position. That is, the head-engagement member 114 is rotatable between a stowed position adjacent to the arm surface and a deployed position away from the arm surface.

In FIG. 11, the head-engagement member 114 is positioned adjacent to an outer surface 1100 of the arm 106. The outer surface 1100 faces a direction away from a user (i.e., opposite a head of a user when the head-mountable device 100 is donned). In addition, the head-engagement member 114 is rotatable about an axis 1102 at the pivot joint 204. In this example of FIG. 11, the axis 1102 is perpendicular (or approximately perpendicular) to the user's head when the head-mountable device 100 is donned. Accordingly, the head-engagement member 114 in FIG. 11 can swivel parallel to the user's head and then bias (or deform) inward (i.e. toward a user's head) to engage the user's hair, skin, or scalp. In certain examples, a head-engagement portion or friction interface of the head-engagement member 114 is positioned on the interior surface of the head-engagement member 114 that abuts the arm 106 when in the stowed position.

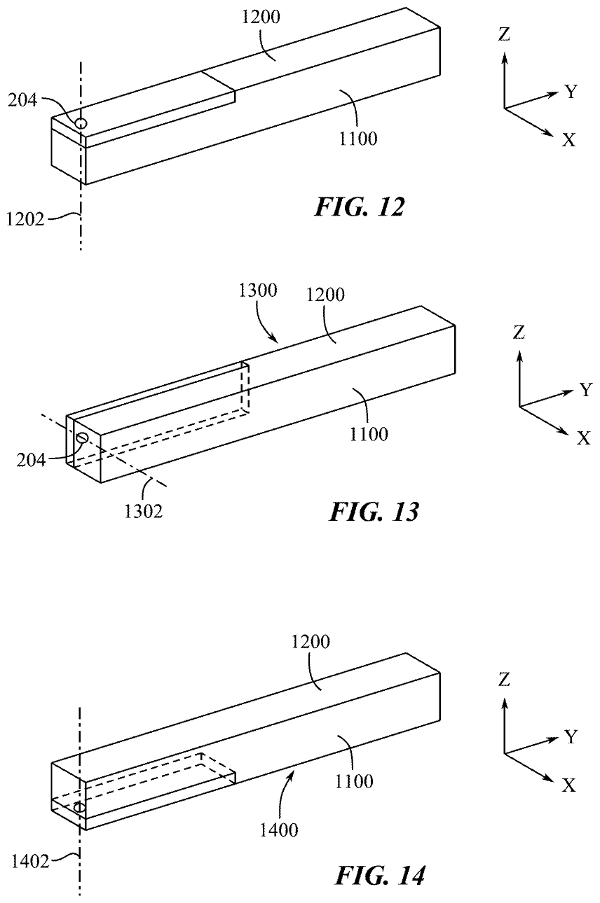

In FIG. 12, the head-engagement member 114 is positioned adjacent to a top surface 1200 of the arm 106. The top surface 1200 faces a direction parallel to a user (i.e., in an upward direction when the head-mountable device 100 is donned). In addition, the head-engagement member 114 is rotatable about an axis 1202 at the pivot joint 204. In this example of FIG. 12, the axis 1202 is parallel (or approximately parallel) to the user's head when the head-mountable device 100 is donned. In this manner, the head-engagement member 114 in FIG. 12 can swivel toward a user's head for head engagement, and away from the user's head to disengage the user's head. In certain examples, a head-engagement portion or friction interface of the head-engagement member 114 is positioned on the interior edge of the head-engagement member 114 and which is flush with an inner surface 1300 discussed below.

In FIG. 13, the head-engagement member 114 is positioned adjacent to an inner surface 1300 of the arm 106. The inner surface 1300 can include an interior surface that faces a direction toward a user (i.e., inward when the head-mountable device 100 is donned). In addition, the head-engagement member 114 is rotatable about an axis 1302 at the pivot joint 204. In this example of FIG. 13, the axis 1302 can be perpendicular (or approximately perpendicular) to the user's head when the head-mountable device 100 is donned. Accordingly, the head-engagement member 114 in FIG. 13 can swivel parallel to the user's head. In some cases, the head-engagement member 114 can then bias (or deform) inward (i.e. toward a user's head) to engage the user's hair, skin, or scalp. Additionally or alternatively, the inside positioning of the head-engagement member 114 in FIG. 13 can facilitate close proximity to the user's head such that, upon swiveling into a deployed position, a friction interface or head-engagement portion of the head-engagement member 114 can engage the user's head. The head-engagement member 114 in FIG. 13 also has a potential aesthetic advantage. Upon deployment of the head-engagement member 114, a recess or cutaway of the arm 106 (where the head-engagement member 114 is positioned when in the depicted stowed position) is concealed or at least partially obscured by the body of the arm 106, as well as the user's head.

In FIG. 14, the head-engagement member 114 is positioned adjacent to a bottom surface 1400 of the arm 106. The bottom surface 1400 faces a direction parallel to a user (i.e., in a downward direction when the head-mountable device 100 is donned). In addition, the head-engagement member 114 is rotatable about an axis 1402 at the pivot joint 204. In this example of FIG. 14, the axis 1402 can be parallel (or approximately parallel) to the user's head when the head-mountable device 100 is donned. In this manner, the head-engagement member 114 in FIG. 14 can swivel toward a user's head for head engagement, and away from the user's head to disengage the user's head. In certain examples, a head-engagement portion or friction interface of the head-engagement member 114 is positioned on the interior edge of the head-engagement member 114 and which is flush with the inner surface 1300 discussed above.

Any of the features, components, and/or parts, including the arrangements and configurations thereof shown in FIGS. 11-14 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 11-14.

As discussed above, the head-mountable device 100 can include a variety of different types of head-engagement members. In addition, the head-mountable device 100 can include various types of arms. The following discussion therefore includes further description regarding examples of arm-tips that can specifically achieve increased friction or increased head engagement. One particular way to do so is to shape (or pre-form) the head-engagement member so as to impart a greater amount of surface area to the arm tip.

FIGS. 15-17 illustrate side views of the distal end 202 of the arm 106 having an example widened portion 1500 in accordance with one or more examples of the present disclosure. As shown in FIGS. 15-17, the widened portion 1500 can include the distal end 202 of the arm 106 having an increased surface area relative to other portions of the arm 106. The widened portion 1500 can include a variety of different shapes and cross-sectional profiles. In particular implementations, the widened portion 1500 spreads or fans out in the Y-Z plane to facilitate more surface contact with a user's head. The widened portion 1500 can include a rounded tip having a bone-shaped end. Accordingly, the widened portion 1500 can specifically include a top surface 1502 that curves upward in the Z-direction and a bottom surface 1504 that curves downward in the Z-direction. The top and bottom surfaces 1502, 1504 of the widened portion 1500 can then wrap around and join at a tip 1506.

In addition, the distal end 202 of the arm 106 can be compliant, malleable, or adjustable. For example, FIG. 15 shows the distal end 202 in an unbiased, unadjusted, or normal state. However, as shown in FIGS. 16 and 17, the distal end 202 can be deflected up or down, and held in a corresponding position. Specifically, as shown in FIG. 16, the distal end 202 can be malleably adjusted upward in the Y-Z plane. In contrast, as shown in FIG. 17, the distal end 202 can be malleably adjusted downward in the Y-Z plane. It will also be appreciated that the distal end 202 can be adjusted along directions outside of the Y-Z plane (e.g., in the X-direction shown in FIG. 1).

In some cases, the distal end 202 (and in particular, the widened portion 1500) can include one or more head-engagement members. For example, as shown in FIG. 15, the widened portion 1500 can include a pair of head-engagement members 114 that can swivel out and away from the arm 106 to engage a user's head (as similarly discussed above in relation to the foregoing figures).

Any of the features, components, and/or parts, including the arrangements and configurations thereof shown in FIGS. 15-17 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 15-17.

As discussed above, the head-mountable device 100 can include a variety of different types of head-engagement members, including head-engagement members with friction interfaces. The following discussion therefore includes further description regarding an example friction interface.

FIG. 18 illustrates a front view of the arm 106 with the head-engagement member 114 in a deployed position and having an example head-engagement surface 1800 in accordance with one or more examples of the present disclosure. The head-engagement surface 1800 can be the same as or similar to the head-engagement surface 812. In particular examples, the head-engagement surface 1800 includes a friction interface 1802. As used herein, the term “friction interface” refers to a portion of the head-engagement member 114 that includes one or more elements to improve or enhance friction properties. Examples of a friction interface can include an area with increased surface roughness, a plurality of micro elements, tacky (e.g., sticky or gripping) material, etc. As specifically shown in FIG. 18, the friction interface 1802 can include directionally-oriented fingers (e.g., fibers, hooks, ridges, teeth, micro elements, etc.). For example, when the head-engagement member 114 is deployed (as shown in FIG. 18), the fingers of the friction interface 1802 can be oriented so as to create a lifting effect for the head-mountable device 100. For example, the directionally oriented fingers of the friction interface 1802 can be angled downward (in the Z-direction) so as to at least partially support a weight of the head-mountable device 100 when donned on a user's head. In these or other examples, the friction interface 1802 is therefore engageable with skin or hair of a user.

Any of the features, components, and/or parts, including the arrangements and configurations thereof shown in FIG. 18 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 18.

As discussed above, the head-mountable device 100 can include head-engagement members with various types of head-engagement surfaces. The following discussion therefore includes further description regarding an example of head-engagement surfaces, including expandable head-engagement surfaces.

FIG. 19 illustrates a side view of the head-mountable device 100 with the head-engagement member 114 having an expandable bladder in accordance with one or more examples of the present disclosure. FIGS. 20A-20B illustrate respective cross-sectional views of the head-engagement member 114 from FIG. 19 in stowed and deployed positions in accordance with one or more examples of the present disclosure.

As shown in FIG. 19, the head-engagement member 114 can include a bladder 1900a in a first state (e.g., in an unexpanded state. However, the bladder 1900a is dashed in FIG. 19 because the head-engagement member 114 is arranged in a deployed position. That is, the bladder can be the bladder 1900a of an unexpanded state when the head-engagement member 114 is in a stowed position (thereby fitting within a profile or silhouette of the arm 106). When the head-engagement member 114 is arranged in the deployed position, however, the bladder 1900a can transform to the bladder 1900b in a second state (e.g., the bladder in an expanded state) as shown. In the expanded state, the bladder 1900b can include an increased surface area for contacting the head of a user.

In these or other examples, various fluid mediums can be utilized for the bladder. For example, the bladder can include gas (e.g., air, nitrogen, etc.) liquid, (e.g., water, oil), or semi-solids or suspensions (e.g., beads, gel, viscous fluid, etc.). In addition, the bladder of the head-engagement member 114 can include various different types of materials. In some examples, the bladder includes an elastomer material.

The fluid medium of the bladder can be actuated in various different ways. In some examples, pistons, actuators, or pumps can be utilized. Additionally or alternatively, the fluid medium of the bladder can be actuated by the very deployment of the head-engagement member 114. For example, by moving the head-engagement member 114 itself from a stowed position to a deployed position, the transition can cause the bladder to expand from the bladder 1900a in a first state to the bladder 1900b in a second state. FIGS. 20A-2B depict such an example.

In FIG. 20A, the head-engagement member 114 is positioned in a stowed position. In this front cross-sectional view, the bladder 1900a in the first state is not visible. However, as the head-engagement member 114 is rotated about an axis 2002 via the pivot joint 204, steps 2000 can impinge upon the bladder. With increased rotation of the head-engagement member 114, the steps 2000 can increasingly impinge upon the bladder (and therefore deform the bladder) to correspondingly advance the fluid medium. The fluid medium is advanced (i.e., pushed, squeezed, or forced) by the steps 2000 until the fluid medium causes the bladder to transform to the bladder 1900b shown in FIG. 20B.

Any of the features, components, and/or parts, including the arrangements and configurations thereof shown in FIGS. 19-20B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 19-20B.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, X (formerly TWITTER®) ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

1. A head-mountable device, comprising:
a display frame;
a display carried by the display frame;
an arm rotatably connected to the display frame at a first joint, the arm comprising a surface; and
a head-engagement member rotatably connected to the arm at a second joint, wherein the head-engagement member is rotatable between a stowed position adjacent to the surface and a deployed position away from the surface.

2. (canceled)

3. The head-mountable device of claim 1, wherein the head-engagement member comprises a spring.

4. The head-mountable device of claim 1, wherein the head-engagement member comprises a preloaded material.

5. The head-mountable device of claim 1, wherein the head-engagement member is slidable along a length of the arm.

6. The head-mountable device of claim 1, wherein the head-engagement member comprises a friction interface.

7. The head-mountable device of claim 6, wherein the friction interface comprises a plurality of fingers oriented to at least partially support a weight of the head-mountable device when donned.

8. The head-mountable device of claim 1, wherein a portion of the head-engagement member is conformable to a head shape of a user.

9. The head-mountable device of claim 1, wherein a portion of the head-engagement member is length adjustable.

10. The head-mountable device of claim 1, wherein a portion of the head-engagement member comprises an overhead linkage positionable against the display frame.

11. The head-mountable device of claim 1, wherein the first joint and the second joint are positioned on a proximal portion of the arm.

12. The head-mountable device of claim 1, wherein the head-engagement member is detachable from the arm.

13. A wearable apparatus, comprising:
a housing;
a viewing window secured to the housing;
a foldable arm connected to the housing and rotatable in a first plan, wherein the support arm is biased into the foldable arm when the support arm is in a stowed position; and
a support arm connected to the foldable arm and rotatable in a second plane substantially perpendicular to the first plane.

14. The wearable apparatus of claim 13, wherein the second plane is substantially parallel to a longitudinal axis of the foldable arm.

15. The wearable apparatus of claim 13, wherein the support arm is positionable inside a profile of the foldable arm.

16. The wearable apparatus of claim 13, wherein the support arm is positionable adjacent to an outer surface of the foldable arm, the outer surface facing a direction opposite a head of a user when the wearable apparatus is donned.

17. (canceled)

18. A removable support assembly for electronic glasses, the removable support assembly comprising:
an adjustable support fin having a head-engagement surface; and
a glasses-arm connector coupled to the adjustable support fin and removably attachable to a glasses arm of the electronic glasses,
wherein the glasses arm is removably attachable to a glasses frame of the electronic glasses, and the glasses arm further comprises:
a proximal end connectable to the glasses frame of the electronic glasses;
a distal end opposite the proximal end; and
an electronics assembly coupled to the glasses arm between the proximal end and the distal end, the electronics assembly including a power supply and a processor.

19. (canceled)

20. The removable support assembly of claim 18, further comprising a housing coupling the support fin to the glasses-arm connector, wherein:
the housing defines a recess, the recess sized and shaped to receive the glasses arm; and
the glasses-arm connector is positioned at the recess.
